(19) United States
(12) Patent Application Publication
(10) Pub. No.: US 2024/0338598 A1
(43) Pub. Date: Oct. 10, 2024

(54) TECHNIQUES FOR TRAINING MACHINE LEARNING MODELS USING ROBOT SIMULATION DATA

(71) Applicant: NVIDIA CORPORATION, Santa Clara, CA (US)

(72) Inventors: Caelan Reed GARRETT, Seattle, WA (US); Fabio TOZETO RAMOS, Seattle, WA (US); Iretiayo AKINOLA, Seattle, WA (US); Alperen DEGIRMENCI, Jersey City, NJ (US); Clemens EPPNER, Seattle, WA (US); Dieter FOX, Seattle, WA (US); Tucker Ryer HERMANS, Salt Lake City, UT (US); Ajay Uday MANDLEKAR, Cupertino, CA (US); Arsalan MOUSAVIAN, Seattle, WA (US); Yashraj Shyam NARANG, Seattle, WA (US); Rowland Wilde O'FLAHERTY, Seattle, WA (US); Balakumar SUNDARALINGAM, Seattle, WA (US); Wei YANG, Lake Forest Park, WA (US)

(21) Appl. No.: 18/606,938

(22) Filed: Mar. 15, 2024

Related U.S. Application Data
(60) Provisional application No. 63/494,801, filed on Apr. 7, 2023.

(51) Int. Cl. G06N 20/00

(52) U.S. Cl. CPC G06N 20/00

(57) ABSTRACT

One embodiment of a method for generating simulation data to train a machine learning model includes generating a plurality of simulation environments based on a user input, and for each simulation environment included in the plurality of simulation environments: generating a plurality of tasks for a robot to perform within the simulation environment, performing one or more operations to determine a plurality of robot trajectories for performing the plurality of tasks, and generating simulation data for training a machine learning model by performing one or more operations to simulate the robot moving within the simulation environment according to the plurality of trajectories.

### CROSS-REFERENCE TO RELATED APPLICATIONS

This application claims priority benefit of the United States Provisional Patent Application titled, “SIMULATED PROCEDURAL DATA GENERATION FOR ROBOTS,” filed on Apr. 7, 2023, and having Ser. No. 63/494,801. The subject matter of this related application is hereby incorporated herein by reference.

### BACKGROUND

### Technical Field

Embodiments of the present disclosure relate generally to computer science, artificial intelligence and robotics and, more specifically, to techniques for training machine learning models using robot simulation data.

### Description of the Related Art

Robots are being increasingly used to perform tasks automatically or autonomously in various environments. For example, in a factory setting, robots are oftentimes used to assemble objects together. One approach for controlling a robot when performing such tasks is to first train a machine learning model with respect to those tasks and then use the trained machine learning model to control the robot to perform the tasks within a particular environment.

Some conventional techniques for training a machine learning machine to control a robot rely on training data that is generated using a physical robot that performs tasks within a real-world environment and also collects sensory data while interacting with objects in the real-world environment. These types of approaches are sometimes referred to as “real-world” training.

One drawback of real-world training is that this type of training typically requires a team of hardware and software engineers to maintain both the robot and the real-world environment. Accordingly, real-world training can be very time consuming and labor intensive. Another drawback of real-world training is that, oftentimes, real-world training techniques are unable to generate the large amounts of training data that usually is required to successfully train a machine learning model to control a robot. For example, during real-world training, the robot may not be exposed to a sufficient number of different types or appearances of objects that the robot could later encounter in various operating scenarios. As another example, during real-world training, the robot may not perform a sufficient number of different types of tasks that the robot is later expected to perform in various operating scenarios. A machine learning model that is trained using an insufficient amount of training data can end up being improperly trained. When the improperly trained machine learning model is deployed to control a robot within a particular environment, the machine learning model may end up failing to control the robot adequately when performing tasks in that environment.

As the foregoing illustrates, what is needed in the art are more effective techniques for controlling robots to perform tasks in real-world environments.

### SUMMARY

One embodiment of the present disclosure sets forth a computer-implemented method for generating simulation data to train a machine learning model. The method includes generating a plurality of simulation environments based on a user input. The method further includes, for each simulation environment included in the plurality of simulation environments: generating a plurality of tasks for a robot to perform within the simulation environment, performing one or more operations to determine a plurality of robot trajectories for performing the plurality of tasks, and generating simulation data for training a machine learning model by performing one or more operations to simulate the robot moving within the simulation environment according to the plurality of trajectories.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques generate relatively larger amounts of training data for training a machine learning model, including training data associated with a greater number of different environments and a greater number of different tasks that a robot can perform in the different environments. The training data can be used to train a machine learning model to, e.g., control a robot to perform those different tasks, after which the trained machine learning model can be deployed to control a physical robot in many different real-world environments. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of one of the compute nodes of FIG. 1, according to various embodiments;

FIG. 3 is a more detailed illustration of one of the training data generators of FIG. 1, according to various embodiments;

FIGS. 4A-4C illustrate exemplar programmatically generated simulation environments, according to various embodiments;

FIGS. 5A-5C illustrate an exemplar programmatically generated robot task, according to various embodiments;

FIGS. 6A-6D illustrate another exemplar programmatically generated robot task, according to various embodiments; and

FIG. 7 is a flow diagram of method steps for generating training data for training a machine learning model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for training machine learning models using robot simulation data. In some embodiments, multiple training data generators execute in parallel to generate training data for training a machine learning model. For a given user input, each training data generator programmatically generates one or more simulation environments and tasks to be performed by a robot within the simulation environment(s). Each training data generator also computes robot trajectories for performing the tasks and simulates, via a physics simulator, the robot moving according to the robot trajectories in order to determine which robot trajectories can satisfy goals of the tasks. During the simulations, each training data generator renders images via virtual cameras that are positioned within the simulation environment(s) where physical cameras would be positioned within real-world environment(s). Thereafter, a model trainer can train a machine learning model, such as a policy model for controlling a robot, using data collected from the simulations and associated rendered images.

The techniques for training machine learning model(s) using robot simulation data have many real-world applications. For example, those techniques could be used to train a machine learning model to control a robot to grasp and manipulate an object, such as picking up the object, placing the object, and/or inserting the object into another object. As another example, those techniques could be used to train a machine learning model to control a robot within an industrial environment, a warehouse, or elsewhere to perform task(s) such as mechanical assembly, machine tending, or the like.

The above examples are not in any way intended to be limiting. As persons skilled in the art will appreciate, as a general matter, the techniques for controlling robots described herein can be implemented in any suitable application.

### System Overview

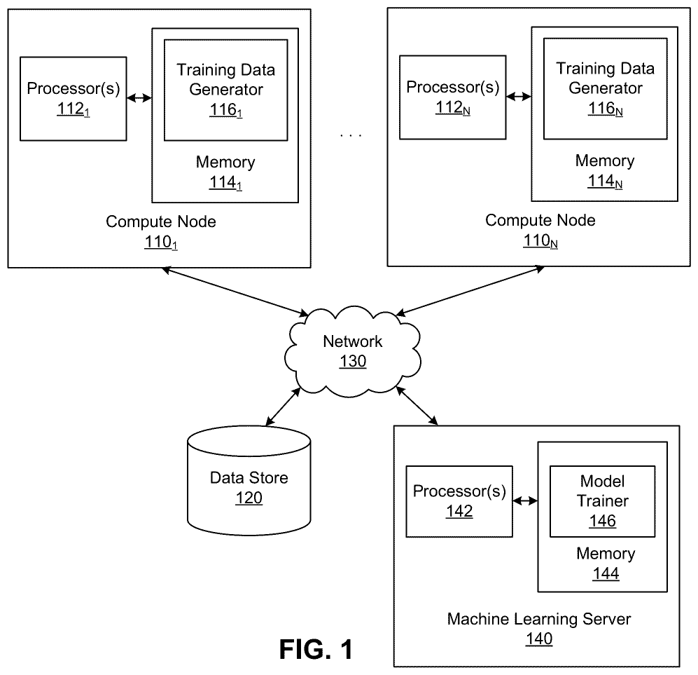

FIG. 1 illustrates a block diagram of a computer-based system 100 configured to implement one or more aspects of at least one embodiment. As shown, the system 100 includes a number of compute nodes 110_{1-N} (referred to herein collectively as compute nodes 110 and individually as a compute node 110 [), a data store 120, and a machine learning server 140 that are in communication over a network 130. The network 130 can be a local area network (LAN), a wide area network (WAN) such as the Internet, a cellular network, and/or any other suitable network.

As shown, training data generators 116_{1-N} (referred to herein collectively as training data generators 116 and individually as a training data generator 116) execute on one or more processors 112_{1-N} (referred to herein collectively as processors 112 and individually as a processor 112) of the compute nodes 110_{1-N} and are stored in system memories 114_{1-N} (referred to herein collectively as memories 114 and individually as a memory 114) of the compute nodes 110_{1-N}. Each of the processors 112 can receive user input from input devices, such as a keyboard or a mouse. In operation, the one or more processors 112 may include one or more primary processors of the compute nodes 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memories 114 of the compute nodes 110 store content, such as software applications and data, for use by the processor(s) 112 and the GPU(s) and/or other processing units. The system memories 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, storage (not shown) can supplement or replace the system memories 114. The storage can include any number and type of external memories that are accessible to the processors 112, GPUs and/or other processing units. For example, and without limitation, the storage can include one or more of a Secure Digital Card, an external Flash memory, a portable compact disc read-only memory (CD-ROM), an optical storage device, a magnetic storage device, and/or any suitable combination of the foregoing.

The compute nodes 110 shown herein are for illustrative purposes only, and variations and modifications are possible without departing from the scope of the present disclosure. For example, the number of processors 112, the number of GPUs and/or other processing unit types, the number of system memories 114, and/or the number of applications included in the system memories 114 can be modified as desired. Further, the connection topology between the various units in FIG. 1 can be modified as desired. In some embodiments, any combination of the processor(s) 112, the system memories 114, GPU(s), and/or other processors can be included in and/or replaced with any type of virtual computing system, distributed computing system, and/or cloud computing environment, such as a public, private, or a hybrid cloud system.

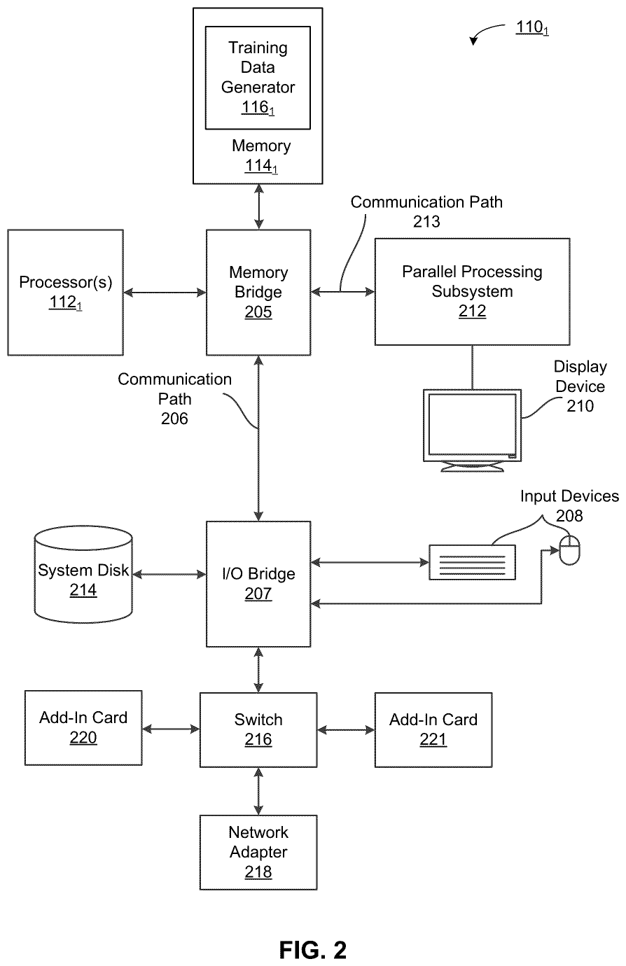

In some embodiments, the training data generators 116 execute in parallel on the compute nodes 110 to generate training data that can be used to train machine learning models. Techniques employed by the training data generators 116 to generate training data are discussed in greater detail below in conjunction with FIGS. 2-7. In some embodiments, training data and/or trained (or deployed) machine learning models can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the data store 120 can be included in one or more of the computes nodes 110 and/or the machine learning server 140.

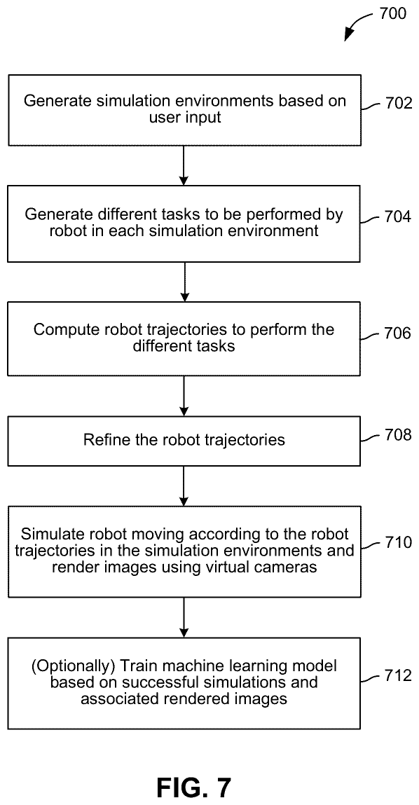

As shown, a model trainer 116 is configured to train one or more machine learning models using training data that is generated by the training data generators 116. The model trainer 116 is stored in a system memory 144, and executes on processor(s) 142, of the computing device 140. Techniques that can be employed by the model trainer 116 to train machine learning model(s) are discussed in greater below in conjunction with FIG. 7. In some embodiments, the system memory 144 and the processor(s) 142 can be similar to the system memories 114 and the processors 112 of the compute nodes 110, described above.

FIG. 2 is a block diagram illustrating the compute node 110₁ of FIG. 1 in greater detail, according to various embodiments. Compute node 110₁ may include any type of computing system, including, without limitation, a server machine, a server platform, a desktop machine, a laptop machine, a hand-held/mobile device, a digital kiosk, an in-vehicle infotainment system, and/or a wearable device. In some embodiments, the compute node 110₁ is a server machine operating in a data center or a cloud computing environment that provides scalable computing resources as a service over a network. In some embodiments, the other compute nodes 110 and the machine learning server 140 of FIG. 1 can include similar components as the compute node 110₁.

In various embodiments, the compute node 110₁ includes, without limitation, the processor(s) 112₁ and the memory(ies) 114₁ coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112₁ for processing. In some embodiments, the compute node 110₁ may be a server machine in a cloud computing environment. In such embodiments, the compute node 110₁ may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the compute node 110₁, such as a network adapter 218 and various add-in cards 220 and 221.

In some embodiments, I/O bridge 207 is coupled to a system disk 214 that may be configured to store content and applications and data for use by processor(s) 112₁ and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within compute node 110₁, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114₁ includes at least one device driver configured to manage the processing operations of the one or more PPUs within parallel processing subsystem 212. In addition, the system memory 114₁ includes the training data generator 116₁. Although described herein primarily with respect to the training data generator 116₁, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In some embodiments, processor(s) 112₁ includes the primary processor of machine learning server 110, controlling and coordinating operations of other system components. In some embodiments, the processor(s) 112₁ issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112₁, and the number of parallel processing subsystems 212, may be modified as desired. For example, in some embodiments, system memory 114₁ could be connected to the processor(s) 112₁ directly rather than through memory bridge 205, and other devices may communicate with system memory 114₁ via memory bridge 205 and processor(s) 112₁. In other embodiments, parallel processing subsystem 212 may be connected to I/O bridge 207 or directly to processor(s) 112₁, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Machine Learning Models to Control Robots Using Simulation Data

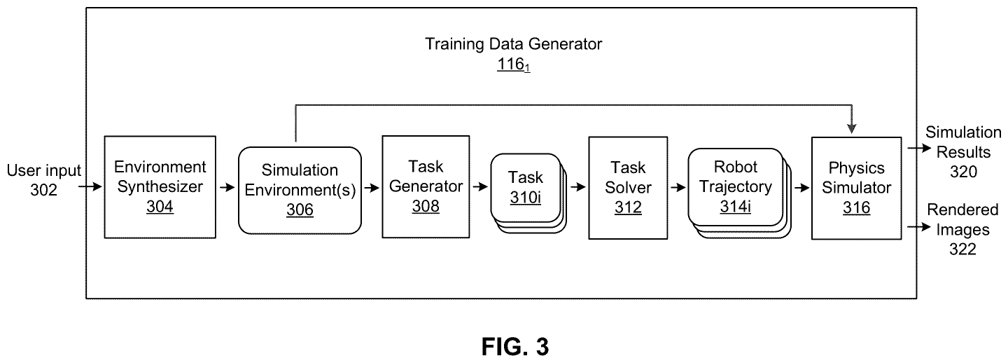

FIG. 3 is a more detailed illustration of the training data generator 116₁ of FIG. 1, according to various embodiments. As shown, the training data generator 116₁ includes an environment synthesizer 304, a task generator 308, a task solver 312, and a physics simulator 316. The other training data generators 116 can include similar components, and perform similar functionality, as the training data generator 116₁.

In operation, the training data generator 116₁ receives a user input 302, and the training data generator 116₁ outputs simulation results 320 and rendered images 322. Any suitable user input 302 can be received in some embodiments. In some embodiments, the user input 302 can include code in a structured language. For example, the code could include one or more keywords describing a scene and one or more keywords describing task(s) to be performed by a robot within the scene. In such a case, the task(s) can include one or more goal conditions (e.g., placing one object on top of another object, opening an object, etc.). In some embodiments, the user input 302 can include natural language text. In such cases, the training data generator 116₁ can employ a large language model (LLM) to generate an interpretation of the natural language text in the form of, e.g., code in a structured language (or receive such an interpretation that is generated using an LLM).

In some embodiments, the simulation results 320 can include physically simulated sequences of robot states, also referred to herein as “trajectories,” of a robot performing tasks that are automatically generated within one or more simulation environments 306. The rendered images 322 can be generated concurrently with, or separate from, the simulation results 320. In some embodiments, the rendered images 322 are generated via virtual cameras that are placed at locations within the simulation environment(s) 306 corresponding to where physical cameras would be placed within real-world environment(s), such as on the wrist of a robot or elsewhere. Although described herein primarily with respect to rendered images as a reference example, in some other embodiments, any suitable sensor data (e.g., depth data, light detection and ranging (LiDAR) data, etc.) can be generated that corresponds to sensor data to be acquired in real-world environment(s)).

The environment synthesizer 304 is a module of the training data generator 116₁ that generates the simulation environment(s) 306 based on the user input 302. In some embodiments, the environment synthesizer 304 generates the simulation environment(s) 306 based on a scene that is specified in the user input 302 by (1) sampling layouts of objects associated with the scene, (2) sampling sets of objects associated with the scene, and (3) selecting as each of the simulation environment(s) 306 one of the sampled layouts and one of the sampled sets of objects that satisfy one or more predefined rules. In some embodiments, the training data generators 116 can use different seeds (e.g., different random numbers) to perform sampling, thereby generating different simulation environments. The layouts of objects can be sampled from a set of predefined layouts that each define an overall structure of a particular type of scene specified in the user input 302. For example, when the particular type of scene is a kitchen, the predefined layouts could include layouts for an I-shaped kitchen, an island kitchen, etc. In some embodiments, the sampling of objects can include sampling different types of objects from a set of predefined objects, sampling different numbers of objects, and/or sampling different sizes of the objects. In some embodiments, the predefined objects can include static objects that are fixed within the simulation environment(s) 306 and/or manipulable objects that a robot can manipulate within the simulation environment(s) 306. In some embodiments, the predefined objects can further include one or more objects having articulations. Returning to the kitchen example, the predefined objects can include static objects such as various refrigerators, microwaves, cabinets, etc. having articulated doors that can open and close, as well as manipulable objects such as various cups, plates, utensils, etc. that a robot can manipulate within a kitchen. In such a case, the environment synthesizer 304 can generate a virtual kitchen by sampling a number of the predefined static and/or manipulable objects, including different types and sizes of the objects. The sampling of object layouts and sets of objects is used to explore the space of possible simulation environments, and the environment synthesizer 304 can select one or more of the sampled layouts and sets of objects that satisfy predefined rules as the simulation environment(s) 306. Returning to the kitchen example, the predefined rules can specify that certain objects cannot be placed next to each other within a kitchen, that objects are not permitted to collide into each other, etc., and such rules can be used to filter out simulation environments that are not physically feasible or otherwise undesirable.

The task generator 308 is a module of the training data generator 116₁ that takes the simulation environment(s) 306 as input and generates a number of tasks 310 that a robot can perform within the simulation environment(s) 306. In some embodiments, the task generator 308 can sample a number of goals for the robot to achieve. Returning to the kitchen example, one goal to achieve could be to place a cup on a table, within a cabinet, or the like. In some embodiments, the tasks 310 can be generated that begin from initial states of the robot, which can also be sampled, and end at the goals to be achieved. In addition or alternatively, in some embodiments, the task generator 308 can perform a search over different combinations of predefined sub-tasks and filter out combinations of sub-tasks that are not feasible. Each sub-task can include a sub-goal. The combinations of sub-tasks that are feasible (i.e., that can be achieved within the simulation environment(s) 306) can then be used as the tasks 310. In some embodiments, the tasks 310 can also be generated based on the user input 302, such as if the user input indicates a particular goal of a task.

The task solver 312 is a module of the training data generator 116₁ that solves for trajectories 314 that the robot can undertake to perform the tasks 310. The trajectories 314 can include states of the robot over multiple time steps. Each robot state can include joint angles and a base position of the robot. Any technically feasible technique, such as a task and motion planning (TAMP) technique, can be used to solve for the robot trajectories 314 that satisfy the constraints and achieve the goals of the tasks 310. In some embodiments, the task solver 312 can also refine the robot trajectories 314. For example, in some embodiments, the task solver 312 can employ a trajectory optimization technique to refine the robot trajectories 314 by modifying portions of the robot trajectories 314 to shorten the durations of those portions, decrease the accelerations in those portions, and/or the like.

The physics simulator 316 is a module of the training data generator 116₁ that takes the simulation environment(s) 306 and the robot trajectories 314 as input and that outputs simulation results 320 and rendered images 322. As described, in some embodiments, the simulation results 320 include physically simulated sequences of robot states, i.e., robot trajectories, of a robot performing the tasks 310, and the simulation results 320 can also indicate which robot trajectories succeeded in achieving goals of the tasks 310. In such cases, the physics simulator 316 can perform physics simulations of the robot moving within the simulation environment(s) 306 according to the robot trajectories 314 that were generated for those simulation environment(s) 306 to determine whether the robot trajectories 314 satisfy the goals of the tasks 310. The physics simulations can include simulating friction, forces, and/or other physical phenomena.

As described, the rendered images 322 can be generated concurrently with, or separate from, the simulation results 320. In some embodiments, the rendered images 322 can include images that are rendered during the physics simulations via virtual cameras that are placed at locations within the simulation environment(s) 306 corresponding to where physical cameras would be placed within real-world environment(s). For example, the virtual cameras could be placed on an arm of the robot or elsewhere within the simulation environment(s) 306.

In some embodiments, the rendered images 322 include images that are rendered using different visual elements, such as different colors and/or textures that are randomly or procedurally generated for objects within the simulation environment(s) 306. In such cases, the colors and/or textures can be obtained in any technically feasible manner, such as by sampling from predefined colors and/or textures, generating diffusion textures via a machine learning model, generating the colors and/or texture randomly, or the like. The colors and/or textures can then be applied to models of objects within the simulation environment(s) 306 that are rendered during the simulations (or separately) as the rendered images 322. Accordingly, images of the simulation environment(s) 306 can be rendered with many different colors and/or textures.

In some embodiments, the physics simulations and/or the rendering of images 322 can be accelerated via one or more GPUs.

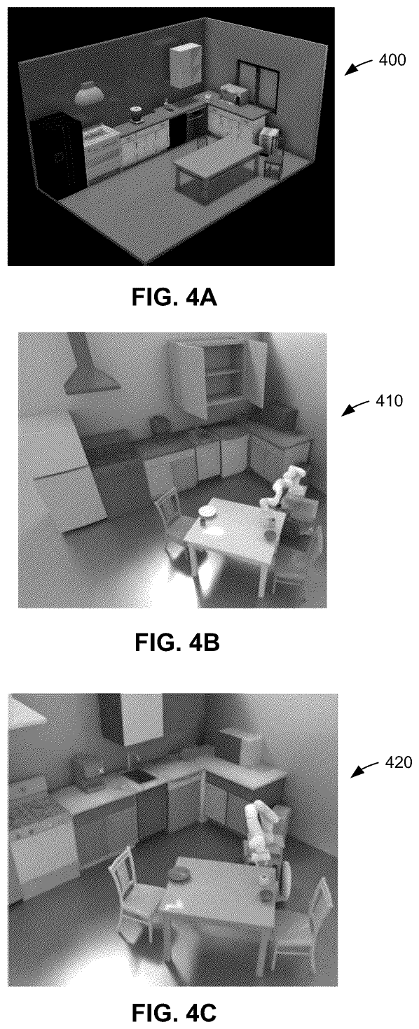

FIGS. 4A-4C illustrate exemplar programmatically generated simulation environments, according to various embodiments. As shown, simulation environments 400, 410, and 420 that include different layouts, objects, and appearances can be generated based on a user input. Illustratively, the user input indicates that the environment is a kitchen, and the simulation environments 400, 410, and 420 represent different kitchens. The simulation environment 400 of FIG. 4A can be generated by a different training data generator 116 or the same training data generator 116 that generates the simulation environments 410 and 420 of FIGS. 4B-4C. Different training data generators 116 can execute in parallel on different computing devices in some embodiments. In addition, the simulation environments 400, 410, and 420 include objects that have different colors and textures, which can be randomly or procedurally generated. Images of different simulation environments, as well as simulation environments having different colors and textures, can be rendered to generate training data that enables a trained machine learning model to be robust to different colors and textures. For example, a machine learning model that is trained using simulation environments including the simulation environments 400, 410, and 420 could perform correctly in various real-world kitchen environments, including real-world kitchens having different layouts, objects, colors, and textures.

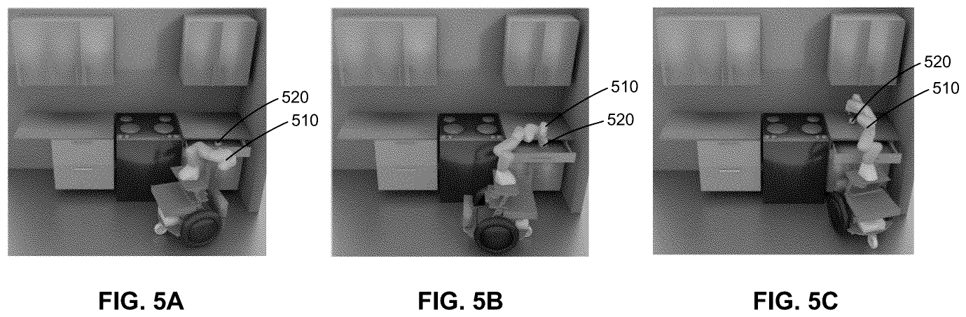

FIGS. 5A-5C illustrate an exemplar programmatically generated robot task, according to various embodiments. As shown, the robot task is to remove a cup 520 from a drawer and place the cup 520 on a table. In some embodiments, the task generator 308 can sample a number of goals for the robot to achieve and generate tasks that begin from an initial state of the robot 510 and end at the goals to be achieved, as described above in conjunction with FIG. 3. In the example of FIGS. 5A-5C, placing the cup 520 on the table is a sampled goal, and the initial state is a state of the robot 510 prior to opening the drawer. Illustratively, the task of removing the cup 520 from the drawer and placing the cup 520 on the table can be generated from the sub-tasks of (1) opening the drawer, shown in FIG. 5A; (2) holding the cup, shown in FIG. 5B; and (3) placing the cup on the table, shown in FIG. 5C. Any number of sub-tasks can be predefined, and the task generator 308 can sample the pre-defined sub-tasks to generate a task that includes a sequence of sub-tasks and is feasible, as described above in conjunction with FIG. 3.

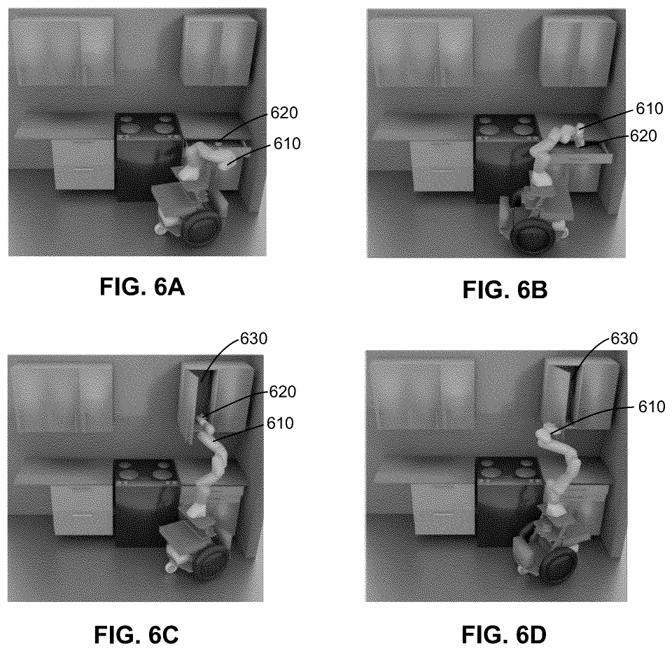

FIGS. 6A-6D illustrate another exemplar programmatically generated robot task, according to various embodiments. As shown, the robot task is to remove a cup 620 from a drawer and place the cup 620 within a cupboard. In the example of FIGS. 6A-6D, placing the cup 620 within a cupboard is a sampled goal, and the initial state is a state of the robot 610 prior to opening the drawer. Illustratively, the task of removing the cup 610 from the drawer and placing the cup 610 within the cupboard can be generated from the sub-tasks of (1) opening the drawer, shown in FIG. 6A; (2) holding the cup, shown in FIG. 6B; (3) placing the cup on within the cupboard, shown in FIG. 6C; and (4) closing the cupboard, shown in FIG. 6D. As described above in conjunction with FIGS. 3 and 5A-5C, any number of sub-tasks can be predefined, and the task generator 308 can sample the pre-defined sub-tasks to generate a task that includes a sequence of sub-tasks and is feasible.

FIG. 7 is a flow diagram of method steps for generating training data for training a machine learning model, according to various embodiments. Although the method steps are described in conjunction with the systems of FIGS. 1-3, persons skilled in the art will understand that any system configured to perform the method steps in any order falls within the scope of the present embodiments.

As shown, a method 700 begins at step 702, where the training data generators 116 generate simulation environments based on user input. In some embodiments, each training data generator 116 generates one or more simulation environments by (1) sampling layouts of objects associated with a scene specified in the user input; (2) sampling sets of objects associated with the scene; and (3) selecting, as the one or more simulation environments, combinations of one or more of the sampled layouts and one or more of the sampled sets of objects that satisfy one or more predefined rules, such as that certain objects cannot be placed next to each other, objects are not permitted to collide into each other, or the like. In some embodiments, the sampling of objects can include sampling different types, numbers, and/or sizes of objects. In some embodiments, the training data generators 116 can use different seeds to perform sampling, thereby generating different simulation environments. In some embodiments, the user input can include code in a structured language that specifies a scene and one or more robot tasks. In some other embodiments, the user input can include natural language text, and an LLM can be employed to generate an interpretation of the user input in the form of, e.g., code in a structured language.

At step 704, each training data generators 116 generates a number of different tasks to be performed by a robot in each simulation environment generated by the training data generator 116. In some embodiments, the training data generators 116 programmatically generate the different tasks by sampling a number of goals and generating the tasks that begin from initial states of the robot, which can also be sampled, and end at the goals. In addition or alternatively, in some embodiments, the training data generators 116 can generate the different tasks by performing a search over different combinations of predefined sub-tasks and filtering out combinations of sub-tasks that are not feasible. In some embodiments, the tasks can also be generated based user input, such as if the user input indicates a particular goal of a task.

At step 706, the training data generators 116 compute robot trajectories to perform the different tasks that are generated at step 704. The training data generators 116 can employ any technically feasible technique, such as a TAMP technique, to solve for the robot trajectories. In some embodiments, one trajectory can be computed for performing each task. In some embodiments, multiple possible trajectories can be computed for performing each task.

At step 708, the training data generators 116 refine the robot trajectories computed at step 706. In some embodiments, the training data generators 116 can refine the robot trajectories by modifying portions of the robot trajectories to shorten the durations of those portions, decrease the accelerations in those portions, and/or the like. The training data generators 116 can employ any technically feasible technique, such as a trajectory optimization technique, to refine the robot trajectories.

At step 710, the training data generators 116 perform simulations of the robot moving according to the robot trajectories in the simulation environments and render images using virtual cameras. In some embodiments, the simulations are performed using a physics simulator that accounts for friction, forces, and/or other physical phenomena. In some embodiments, the images are rendered using virtual cameras that are placed at locations within the simulation environments where physical cameras would be placed in real-world environments, such as on arm of the robot or elsewhere within the simulation environments. In some embodiments, the images can be rendered concurrently with, or separate from, the simulations. In some embodiments, the images can be rendered using different visual elements, such as different colors and/or textures that are randomly or procedurally generated for different objects within the simulation environments by sampling from predefined colors and/or textures, generating diffusion textures via a machine learning model, generating the colors and/or texture randomly, or in any other technically feasible manner. Although described herein primarily with respect to rendered color images as a reference example, in some embodiments, any suitable sensor data (e.g., depth data, light detection and ranging (LiDAR) data, etc.) can be generated that corresponds to sensor data that will be acquired in real-world environments.

At optional step 712, the model trainer 146 trains a machine learning model based on successful simulations and associated rendered images. Each successful simulation is a simulation in which the goal condition(s) of a task are satisfied by a robot within one of the simulation environments at step 710. The training data generators 116 can store simulation data and rendered images from the successful simulations in any technically feasible manner, such as within a dataset or database that is stored in the data store 120, and the model trainer 146 can retrieve the stored data for use in training a machine learning model. In some embodiments, any technically feasible machine learning model can be trained. For example, the machine learning model could be a policy model that generates actions for controlling a robot. Such a policy could be trained using, e.g., supervised learning, reinforcement learning, or imitation learning with virtual reality (VR) demonstrations. As another example, the machine learning model could be a segmentation model that generates segmentations of objects within images captured by a camera mounted on a robot or within an environment in which a robot operates. In some embodiments, machine learning model(s) can be trained based on the successful simulations and associated rendered images in any technically feasible manner. For example, in some embodiments, a machine learning model to control a robot can be trained using supervised learning based on trajectories associated with the successful simulations, with steps of those trajectories being used as actions that are the expected output of the machine learning model and associated rendered images being used as input into the machine learning model during training.

In sum, techniques are disclosed for training machine learning models using robot simulation data. In some embodiments, multiple training data generators execute in parallel to generate training data for training a machine learning model. For a given user input, each training data generator programmatically generates one or more simulation environments and tasks to be performed by a robot within the simulation environment(s). Each training data generator also computes robot trajectories for performing the tasks and simulates, via a physics simulator, the robot moving according to the robot trajectories in order to determine which robot trajectories can satisfy goals of the tasks. During the simulations, each training data generator renders images via virtual cameras that are positioned within the simulation environment(s) where physical cameras would be positioned within real-world environment(s). Thereafter, a model trainer can train a machine learning model, such as a policy model for controlling a robot, using data collected from the simulations and associated rendered images.

At least one technical advantage of the disclosed techniques relative to the prior art is that the disclosed techniques generate relatively larger amounts of training data for training a machine learning model, including training data associated with a greater number of different environments and a greater number of different tasks that a robot can perform in the different environments. The training data can be used to train a machine learning model to, e.g., control a robot to perform those different tasks, after which the trained machine learning model can be deployed to control a physical robot in many different real-world environments. These technical advantages represent one or more technological improvements over prior art approaches.

1. In some embodiments, a computer-implemented method for generating simulation data to train a machine learning model comprises generating a plurality of simulation environments based on a user input, and for each simulation environment included in the plurality of simulation environments generating a plurality of tasks for a robot to perform within the simulation environment, performing one or more operations to determine a plurality of robot trajectories for performing the plurality of tasks, and generating simulation data for training a machine learning model by performing one or more operations to simulate the robot moving within the simulation environment according to the plurality of trajectories.

2. The computer-implemented method of clause 1, wherein the simulation data comprises (i) one or more trajectories included in the plurality of trajectories that satisfy one or more goals of the plurality of tasks, and (ii) a plurality of rendered images of the simulation environment.

3. The computer-implemented method of clauses 1 or 2, wherein the plurality of rendered images include at least two images rendered using at least one of different colors or different textures applied to one or more objects within the simulation environment.

4. The computer-implemented method of any of clauses 1-3, further comprising performing one or more operations to refine at least one robot trajectory included in the plurality of robot trajectories.

5. The computer-implemented method of any of clauses 1-4, wherein generating the plurality of simulation environments comprises performing one or more operations to sample at least one of (i) different layouts of objects from a plurality of predefined layouts, (ii) different objects from a plurality of predefined objects, or (iii) different sizes of objects, to generate a plurality of intermediate simulation environments, and selecting the plurality of simulation environments from the plurality of intermediate simulation environments based one or more predefined rules.

6. The computer-implemented method of any of clauses 1-5, wherein at least two of the plurality of simulation environments are generated based on at least one of predefined layouts of objects or predefined three-dimensional (3D) models of objects.

7. The computer-implemented method of any of clauses 1-6, wherein generating the plurality of tasks comprises performing one or more operations to determine at least one of a plurality of goals or a plurality of sub-tasks associated with the plurality of tasks.

8. The computer-implemented method of any of clauses 1-7, further comprising generating, via a large language model (LLM), an interpretation of the user input.

9. The computer-implemented method of any of clauses 1-8, wherein at least two of the plurality of simulation environments are generated in parallel via a plurality of computing devices.

10. The computer-implemented method of any of clauses 1-9, further comprising performing one or more operations to train a machine learning model based on the simulation data generated for the plurality of simulation environments.

11. In some embodiments, one or more non-transitory computer-readable media store instructions that, when executed by at least one processor, cause the at least one processor to perform the steps of generating a plurality of simulation environments based on a user input, and for each simulation environment included in the plurality of simulation environments generating a plurality of tasks for a robot to perform within the simulation environment, performing one or more operations to determine a plurality of robot trajectories for performing the plurality of tasks, and generating simulation data for training a machine learning model by performing one or more operations to simulate the robot moving within the simulation environment according to the plurality of trajectories.

12. The one or more non-transitory computer-readable media of clause 11, wherein the simulation data comprises (i) one or more trajectories included in the plurality of trajectories that satisfy one or more goals of the plurality of tasks, and (ii) a plurality of rendered images of the simulation environment.

13. The one or more non-transitory computer-readable media of clauses 11 or 12, wherein the plurality of rendered images include at least two images rendered using at least one of different colors or different textures applied to one or more objects within the simulation environment.

14. The one or more non-transitory computer-readable media of any of clauses 11-13, wherein the instructions, when executed by at the least one processor, further cause the at least one processor to perform the step of performing one or more operations to refine at least one robot trajectory included in the plurality of robot trajectories.

15. The one or more non-transitory computer-readable media of any of clauses 11-14, wherein generating the plurality of simulation environments comprises performing one or more operations to sample at least one of (i) different layouts of objects from a plurality of predefined layouts, (ii) different objects from a plurality of predefined objects, or (iii) different sizes of objects, to generate a plurality of intermediate simulation environments, and selecting the plurality of simulation environments from the plurality of intermediate simulation environments based one or more predefined rules.

16. The one or more non-transitory computer-readable media of any of clauses 11-15, wherein at least two of the plurality of simulation environments are generated in parallel via a plurality of computing devices.

17. The one or more non-transitory computer-readable media of any of clauses 11-16, further comprising performing one or more operations to train a machine learning model based on the simulation data generated for the plurality of simulation environments.

18. The one or more non-transitory computer-readable media of any of clauses 11-17, wherein the machine learning model is trained to control a physical robot.

19. The one or more non-transitory computer-readable media of any of clauses 11-18, wherein the one or more operations to train the machine learning model include one or more supervised learning operations.

20. In some embodiments, a system comprises one or more memories storing instructions, and one or more processors that are coupled to the one or more memories and, when executing the instructions, are configured to generate a plurality of simulation environments based on a user input, and for each simulation environment included in the plurality of simulation environments generate a plurality of tasks for a robot to perform within the simulation environment, perform one or more operations to determine a plurality of robot trajectories for performing the plurality of tasks, and generate simulation data for training a machine learning model by performing one or more operations to simulate the robot moving within the simulation environment according to the plurality of trajectories.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating simulation data to train a machine learning model, the method comprising:
generating a plurality of simulation environments based on a user input; and
for each simulation environment included in the plurality of simulation environments:
generating a plurality of tasks for a robot to perform within the simulation environment,
performing one or more operations to determine a plurality of robot trajectories for performing the plurality of tasks, and
generating simulation data for training a machine learning model by performing one or more operations to simulate the robot moving within the simulation environment according to the plurality of trajectories.

2. The computer-implemented method of claim 1, wherein the simulation data comprises (i) one or more trajectories included in the plurality of trajectories that satisfy one or more goals of the plurality of tasks, and (ii) a plurality of rendered images of the simulation environment.

3. The computer-implemented method of claim 2, wherein the plurality of rendered images include at least two images rendered using at least one of different colors or different textures applied to one or more objects within the simulation environment.

4. The computer-implemented method of claim 1, further comprising performing one or more operations to refine at least one robot trajectory included in the plurality of robot trajectories.

5. The computer-implemented method of claim 1, wherein generating the plurality of simulation environments comprises:
performing one or more operations to sample at least one of (i) different layouts of objects from a plurality of predefined layouts, (ii) different objects from a plurality of predefined objects, or (iii) different sizes of objects, to generate a plurality of intermediate simulation environments; and
selecting the plurality of simulation environments from the plurality of intermediate simulation environments based one or more predefined rules.

6. The computer-implemented method of claim 1, wherein at least two of the plurality of simulation environments are generated based on at least one of predefined layouts of objects or predefined three-dimensional (3D) models of objects.

7. The computer-implemented method of claim 1, wherein generating the plurality of tasks comprises performing one or more operations to determine at least one of a plurality of goals or a plurality of sub-tasks associated with the plurality of tasks.

8. The computer-implemented method of claim 1, further comprising generating, via a large language model (LLM), an interpretation of the user input.

9. The computer-implemented method of claim 1, wherein at least two of the plurality of simulation environments are generated in parallel via a plurality of computing devices.

10. The computer-implemented method of claim 1, further comprising performing one or more operations to train a machine learning model based on the simulation data generated for the plurality of simulation environments.

11. One or more non-transitory computer-readable media storing instructions that, when executed by at least one processor, cause the at least one processor to perform the steps of:
generating a plurality of simulation environments based on a user input; and
for each simulation environment included in the plurality of simulation environments:
generating a plurality of tasks for a robot to perform within the simulation environment,
performing one or more operations to determine a plurality of robot trajectories for performing the plurality of tasks, and
generating simulation data for training a machine learning model by performing one or more operations to simulate the robot moving within the simulation environment according to the plurality of trajectories.

12. The one or more non-transitory computer-readable media of claim 11, wherein the simulation data comprises (i) one or more trajectories included in the plurality of trajectories that satisfy one or more goals of the plurality of tasks, and (ii) a plurality of rendered images of the simulation environment.

13. The one or more non-transitory computer-readable media of claim 12, wherein the plurality of rendered images include at least two images rendered using at least one of different colors or different textures applied to one or more objects within the simulation environment.

14. The one or more non-transitory computer-readable media of claim 11, wherein the instructions, when executed by at the least one processor, further cause the at least one processor to perform the step of performing one or more operations to refine at least one robot trajectory included in the plurality of robot trajectories.

15. The one or more non-transitory computer-readable media of claim 11, wherein generating the plurality of simulation environments comprises:
performing one or more operations to sample at least one of (i) different layouts of objects from a plurality of predefined layouts, (ii) different objects from a plurality of predefined objects, or (iii) different sizes of objects, to generate a plurality of intermediate simulation environments; and
selecting the plurality of simulation environments from the plurality of intermediate simulation environments based one or more predefined rules.

16. The one or more non-transitory computer-readable media of claim 11, wherein at least two of the plurality of simulation environments are generated in parallel via a plurality of computing devices.

17. The one or more non-transitory computer-readable media of claim 11, further comprising performing one or more operations to train a machine learning model based on the simulation data generated for the plurality of simulation environments.

18. The one or more non-transitory computer-readable media of claim 17, wherein the machine learning model is trained to control a physical robot.

19. The one or more non-transitory computer-readable media of claim 17, wherein the one or more operations to train the machine learning model include one or more supervised learning operations.

20. A system, comprising:
one or more memories storing instructions; and
one or more processors that are coupled to the one or more memories and, when executing the instructions, are configured to:
generate a plurality of simulation environments based on a user input, and
for each simulation environment included in the plurality of simulation environments:
generate a plurality of tasks for a robot to perform within the simulation environment;
perform one or more operations to determine a plurality of robot trajectories for performing the plurality of tasks; and
generate simulation data for training a machine learning model by performing one or more operations to simulate the robot moving within the simulation environment according to the plurality of trajectories.
